(19) United States
(12) Patent Application Publication
(10) Pub. No.: US 2025/0187971 A1
(43) Pub. Date: Jun. 12, 2025

(54) BOROALUMINOSILICATE GLASS COMPOSITION HAVING HIGH FUSION FLOW RATE AND ADVANTAGED PAIR SHAPING TEMPERATURE

(71) Applicant: CORNING INCORPORATED, CORNING, NY (US)

(72) Inventors: Timothy Michael Gross, Painted Post, NY (US); Aaron Joshua Hade, Corning, NY (US); Chunhong Chelsie He, Horseheads, NY (US); Jian Luo, Cupertino, CA (US)

(21) Appl. No.: 18/843,827

(22) PCT Filed: Mar. 3, 2023
(86) PCT No.: PCT/US2023/014462

§ 371 Date: Sep. 4, 2024

Related U.S. Application Data
(60) Provisional application No. 63/318,221, filed on Mar. 9, 2022.

(51) Int. Cl. C03C 3/091; B32B 17/10; C03B 23/025; C03C 3/097

(52) U.S. Cl. CPC C03C 3/091; B32B 17/10036; C03C 3/097; B32B 2250/03; B32B 2250/40; B32B 2307/7376; C03B 23/0252

(57) ABSTRACT

Disclosed herein are embodiments of a glass composition including about 55 mol % to about 67 mol % SiO₂, about 10 mol % to about 13 mol % B₂O₃, about 11 mol % to about 15 mol % Al₂O₃, and about 12 mol % to about 16 mol % alkali oxide. In one or more embodiments, the glass composition comprises a temperature at which a viscosity of the borosilicate glass composition is 10¹¹ P from about 630° C. to about 650° C. Also disclosed is a method of forming a glass ply. In the method, a trough in an isopipe is overflowed with at least two streams of the glass composition, and the at least two streams of the glass composition are fused at a root of the isopipe to form the glass ply. The glass ply can be pair-shaped to form laminates for use as automotive glazing.

### PRIORITY

This application claims the benefit of priority under 35 U.S.C. § 119 of U.S. Provisional Application Ser. No. 63/318,221 filed on Mar. 9, 2022, the content of which is relied upon and incorporated herein by reference in its entirety.

### BACKGROUND

The disclosure relates to glass compositions and glass articles made therefrom, and more particularly to boroaluminosilicate glass compositions capable of being fusion formed at relatively high fusion flow rates.

Glass is used in windows due to its optical clarity and durability. Automotive and architectural windows may include a single glass ply or a laminate that includes two glass plies with an interlayer of a polymeric material disposed in between. For automotive applications in particular, there is a trend toward using laminates for improved fuel economy and/or impact performance. Certain laminate designs may utilize a thicker outer glass ply and a thin inner glass ply. Soda lime glass is often used for both the inner and outer plies because it is readily available in a variety of sizes and thicknesses and is relatively inexpensive. However, as compared to certain other glass compositions, soda lime glass is relatively disadvantaged in terms of thermal and mechanical properties and in terms of weight. Accordingly, there is a need for improved glasses for use as both the thinner inner ply and the thicker outer glass ply in a laminate.

### SUMMARY

According to an aspect, embodiments of the present disclosure relate to a glass composition including about 55 mol % to about 67 mol % SiO₂, about 10 mol % to about 13 mol % B₂O₃, about 11 mol % to about 15 mol % Al₂O₃, and about 12 mol % to about 16 mol % alkali oxide. In one or more embodiments, the glass composition comprises a temperature at which a viscosity of the borosilicate glass composition is 10¹¹ P from about 630° C. to about 650° C.

According to another aspect, embodiments of the present disclosure relate to a method of forming a glass ply. In the method, a trough in an isopipe is overflowed with at least two streams of a glass composition. In one or more embodiments, the glass composition includes from about 55 mol % to about 67 mol % of SiO₂, about 10 mol % to about 13 mol % B₂O₃, from about 11 mol % to about 15 mol % Al₂O₃, and from about 12 mol % to about 16 mol % alkali oxide. The at least two streams of the glass composition are fused at a root of the isopipe to form the glass ply according to the method.

According to still another aspect, embodiments of the present disclosure relate to a method in which a stack of a first glass play and a second glass ply is arranged on a bending ring having an open interior. According to one or more embodiments of the method, the first glass ply has a first temperature at which a viscosity of the first glass ply is 10¹¹ Poise, and the second glass ply has a second temperature at which a viscosity of the second glass ply is 10¹¹ Poise. In embodiments, the first temperature is different from the second temperature. The stack is to a temperature at which the stack sags into the open interior of the bending ring. In one or more embodiments, the first glass ply is made up of a first glass composition including from about 55 mol % to about 67 mol % of SiO₂, about 10 mol % to about 13 mol % B₂O₃, from about 11 mol % to about 15 mol % Al₂O₃, and from about 12 mol % to about 16 mol % alkali oxide.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 is an illustration of a vehicle including a glass article or laminate according to one or more embodiments;

FIG. 2 is a side view illustration of a glass article according to one or more embodiments;

FIG. 3 is a side view illustration of a laminate including a glass article according to one or more embodiments;

FIG. 4 is a side view illustration of a curved laminate including a glass article according to one or more embodiments;

FIG. 5 depicts a fusion-forming apparatus for fusion forming a glass ply of boroaluminosilicate glass composition, according to an exemplary embodiment; and

FIG. 6 depicts a system including a sensor configured to send and receive signals through a glass laminate having at least one glass ply made of the boroaluminosilicate glass composition, according to an exemplary embodiment;

### DETAILED DESCRIPTION

Reference will now be made in detail to various embodiments of glass plies and laminates made from a boroaluminosilicate glass composition as well as methods of producing same, examples of which are illustrated in the accompanying drawings. Embodiments of the disclosure relate to a boroaluminosilicate glass composition that is able to be fusion formed at a high mass flow rate. Advantageously, the high mass flow rate decreases production cost. Further, the composition provides a temperature at which the glass has a viscosity of 10¹¹ Poise (T₁₁ temperature) that is conducive to current pair-shaping techniques. In embodiments, the boroaluminosilicate glass composition includes from about 55 mol % to about 67 mol % SiO₂, from about 10 mol % to about 13 mol B₂O₃, from about 11 mol % to about 15 mol % Al₂O₃, and from about 12 mol % to about 16 mol % of an alkai oxide (one or more of Li₂O, K₂O, and primarily Na₂O). The boroaluminosilicate glass composition described herein is particularly suitable for laminate applications, such as automotive glazings. More particularly, the boroaluminosilicate glass composition can be used as a thinner, interior facing glass ply of an automotive glazing. These and other aspects and advantages of the disclosed boroaluminosilicate glass composition will be described more fully below. The embodiments discussed herein are presented by way of illustration and not limitation.

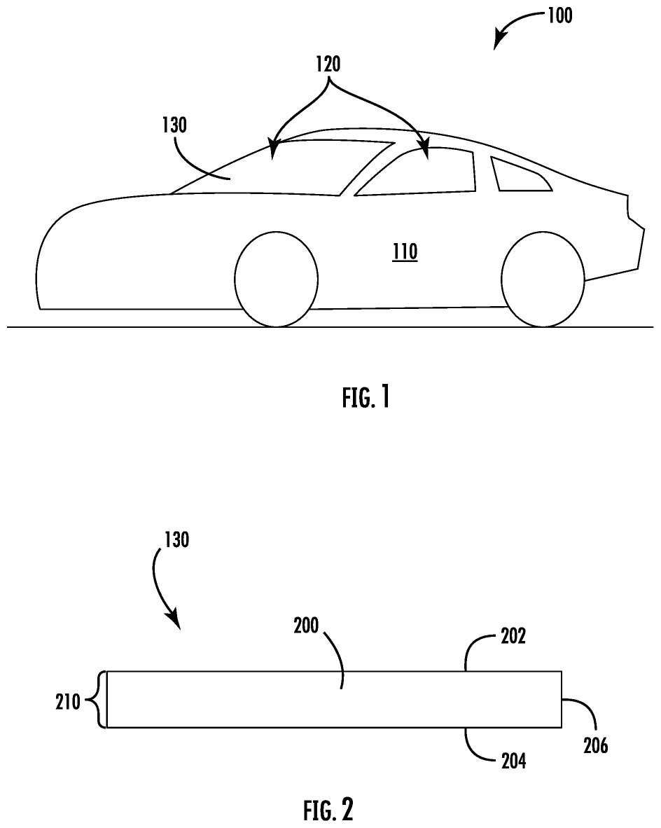

Embodiments to the boroaluminosilicate glass composition are described herein in relation to a vehicle 100 as shown in FIG. 1. The vehicle 100 includes a body 110 defining an interior and at least one opening 120 in communication with the interior. The vehicle 100 further includes an automotive glazing 130, i.e., window, disposed in the opening 120. The automotive glazing comprises at least one ply of the boroaluminosilicate glass composition described herein. The automotive glazing 130 may form at least one of the sidelights, windshield, rear window, windows, and sunroofs in the vehicle 100. In some embodiments, the automotive glazing 130 may form an interior partition (not shown) within the interior of the vehicle 100, or may be disposed on an exterior surface of the vehicle 100 and form, e.g., an engine block cover, headlight cover, taillight cover, door panel cover, or pillar cover. As used herein, vehicle includes automobiles (an example of which is shown in FIG. 1), rolling stock, locomotive, boats, ships, airplanes, helicopters, drones, space craft, and the like. Further, while the present disclosure is framed in terms of a vehicle, the boroaluminosilicate glass composition may be used in other contexts, such as architectural glazing or bullet-resistant glazing applications.

As shown in FIG. 2, in embodiments, the automotive glazing 130 includes at least one glass ply 200 comprising, consisting of or consisting essentially of the embodiments of the boroaluminosilicate glass composition described herein. In one or more embodiments, the automotive glazing 130 includes only a single glass ply 200 (i.e., the single glass ply is sometimes referred in the industry as a monolith). As can be seen in FIG. 2, the glass ply 200 has a first major surface 202 and a second major surface 204. The first major surface 202 is opposite to the second major surface 204. A minor surface 206 extends around the periphery of the glass ply 200 and connects the first major surface 202 and the second major surface 204.

A first thickness 210 is defined between the first major surface 202 and the second major surface 204. In embodiments, the first thickness 210 is from about 0.1 mm to about 2.0 mm, in particular about 0.3 mm to about 1.5 mm, and most particularly about 0.5 mm to about 1.1 mm.

In some embodiments, the glass ply may have curvature, such as rounded geometry or tubular, such as where the first major surface is an exterior and the second major surface is an interior surface of the tube. In some embodiments, a perimeter of the glass ply is generally rectilinear and in other embodiments the perimeter is complex. The first major surface may have apertures, slots, holes, bumps, dimples, or other geometry.

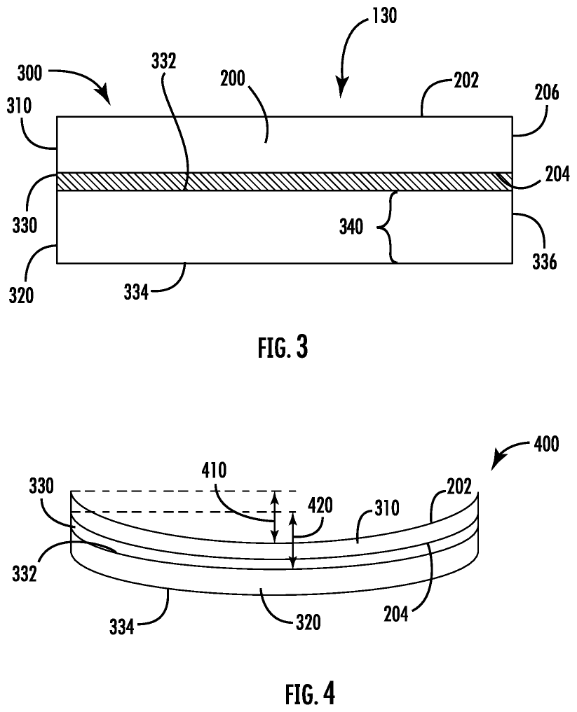

FIG. 3 depicts an embodiment of the automotive glazing 130 in which the automotive glazing 130 is a laminate structure 300 including the glass ply 200 of FIG. 2 as a first glass ply 310. As referenced above, the glass ply 200 can comprise, consist of or consist essentially of an embodiment of the boroaluminosilicate glass composition described herein. In the embodiment shown in FIG. 3, the first glass ply 310 is joined to a second glass ply 320 by an interlayer 330. In particular, the second glass ply 320 has a third major surface 332 and a fourth major surface 334. The third major surface 332 is opposite to the fourth major surface 334. A minor surface 336 extends around the periphery of the second glass ply 320 and connects the third major surface 332 and the fourth major surface 334.

A second thickness 340 is defined between the third major surface 332 and the fourth major surface 334. In embodiments, the second thickness 340 is greater than the first thickness 210 of the first glass ply 310. In embodiments, the second glass thickness is greater than 2 mm. In embodiments, the total glass thickness (i.e., the first thickness 210 plus the second thickness 340) is 8 mm or less, 7 mm or less, 6.5 mm or less, 6 mm or less, 5.5 mm or less, or 5 mm or less. In embodiments, the lower limit of the total glass thickness is about 2 mm.

In embodiments, the second glass ply 320 comprises a glass composition that is different from the boroaluminosilicate glass composition of the first glass ply 310. In embodiments, the second glass composition comprises a soda lime silicate composition or a borosilicate glass composition (especially a fusion-formable borosilicate glass composition comprising, for example, 74 mol % to 80 mol % of SiO₂, 2.5 mol % to 5 mol % of Al₂O₃, 11.5 mol % to 14.5 mol % B₂O₃, 4.5 mol % to 8 mol % Na₂O, 0.5 mol % to 3 mol % K₂O, 0.5 mol % to 2.5 mol % MgO, and 0 mol % to 4 mol % CaO). The second glass ply 320 may be formed from any of the borosilicate glass compositions described in international patent application no. PCT/US2021/61966, filed on Dec. 6, 2021, entitled “Glass with Unique Fracture Behavior for Vehicle Windshield,” hereby incorporated by reference in its entirety. In embodiments, the second glass ply 320 composition may comprise concentrations in mole percent on an oxide basis of SiO₂, B₂O₃, one or more alkali metal oxides (R₂O), Al₂O₃, and one or more divalent cation oxides RO, such that the concentrations satisfy some (e.g., one or a combination of more than one) or all the relationships: (relationship 1) SiO₂≥72 mol %, such as SiO₂≥72.0, such as SiO₂≥73.0, such as SiO₂≥74.0, and/or SiO₂≤92, such as SiO₂≤90; (relationship 2) B₂O₃≥10 mol %, such as B₂O₃≥10.0, such as B₂O₃≥10.5, and/or B₂O₃≤20, such as B₂O₃≤18; (relationship 3) (R₂O+R′O)≥ Al₂O₃, such as (R₂O+R′O)≥ (Al₂O₃+1), such as (R₂O+R′O)≥ (Al₂O₃+2), and/or (relationship 4) 0.80≤(1-[(2R₂O+2R′O)/(SiO₂+2Al₂O₃+2B₂O₃)])≤0.93, where R₂O is the sum of the concentrations of the one or more alkali metal oxides and, when included in the borosilicate glass composition, R′O is the sum of the concentrations of the one or more divalent cation oxides. R₂O may be the sum of Li₂O, Na₂O, K₂O, Rb₂O, Cs₂O for example, and R′O may be the sum of MgO, CaO, SrO, BaO, ZnO for example.

In embodiments, the glass composition of the second glass ply 320 may include amounts of Al₂O₃ and Na₂O that satisfy the relationship Na₂O>Al₂O₃+1, (e.g., Na₂O>Al₂O₃+1.25, Na₂O>Al₂O₃+1.5, Na₂O>Al₂O₃+1.75, Na₂O>Al₂O₃+2.0). In embodiments, the Al₂O₃ content of the glass composition of the second glass ply 320 is greater than or equal to 2.0 mol % and less than or equal to 5.0 mol % (e.g., greater than or equal to 2.5 mol % and less than or equal to 5.0 mol %, greater than or equal to 3.0 mol % or les than or equal to 5 mol %). When the composition of the second glass ply 320 has greater than or equal to 12.0 mol % B₂O₃ (e.g., greater than or equal to 13.0 mol % B₂O₃, greater than or equal to 14.0 mol % B₂O₃, greater than or equal to 15.0 mol % B₂O₃ and less than or equal to 16 mol % B₂O₃), such Al₂O₃ content is sufficient to prevent phase separation of the borosilicate glass, yet low enough such that SiO₂ and B₂O₃ are the primary network formers in the glass. With the Al₂O₃ content at such levels, Na₂O content in excess of Al₂O₃ assists in dissolution of the silica during melting of the glass. In embodiments, the Na₂O content in the glass composition of the second glass ply 320 is less than or equal to 6.25 mol % (e.g., less than or equal to 6.20 mol %, less than or equal to 6.15 mol %, less than or equal to 6.10 mol %, less than or equal to 6.05 mol %, less than or equal to 6.0 mol %,), as Na₂O in excess of this amount may lead to an undesirably high CTE of the glass. In such embodiments, the Na₂O content is at least 4.0 mol %. In embodiments, when the Na₂O content of the second glass plie 320 satisfies these criteria, K₂O, if included, is included in an amount that is less than Na₂O, such as in an amount that is greater than or equal to 0.8 mol % and less than or equal to 5 mol %, but less than the amount of Na₂O, as K₂O tends to increase CTE to a greater extent than Na₂O per unit of composition. For example, in embodiments, the glass composition of the second glass ply 320 may include a ratio of K₂O to Na₂O that is from about 0.1 to about 0.75. Glass compositions meeting the aforementioned constraints may be suitable for fusion-forming and exhibit the unique fracture behavior described herein, while still having favorably low CTEs.

Further, in embodiments, the first glass ply 310 and/or the second glass ply 320 may be strengthened. For example, the first glass ply 310 and/or the second glass ply 320 may be thermally, chemically and/or mechanically strengthened. In particular, in embodiments, the first glass ply 310 and/or the second glass ply 320 is chemically strengthened through an ion-exchange treatment. In one or more embodiments, the first glass ply 310 and/or the second glass ply 320 is mechanically strengthened by utilizing a mismatch of the coefficient of thermal expansion between portions of the ply to create a compressive stress region and a central region exhibiting a tensile stress. In some embodiments, the first glass ply 310 and/or the second glass ply 320 may be strengthened thermally by heating the glass ply to a temperature above the glass transition point and then rapidly quenching. In some embodiments, various combinations of chemical, mechanical and thermal strengthening may be used to strengthen the first glass ply 310. In one or more embodiments, the first glass ply 310 is strengthened while the second glass ply 320 is is unstrengthened (but may optionally be annealed) and exhibits a surface compressive stress of less than about 3 MPa, or about 2.5 MPa or less, 2 MPa or less, 1.5 MPa or less, 1 MPa or less, or about 0.5 MPa or less.

In one or more embodiments, the interlayer 330 bonds the second major surface 204 of the first glass ply 310 to the third major surface 332 of the second glass ply 320. In embodiments, the interlayer 330 comprises a polymer, such as at least one of polyvinyl butyral (PVB), acoustic PVB (APVB), an ionomer, an ethylene-vinyl acetate (EVA) and a thermoplastic polyurethane (TPU), a polyester (PE), a polyethylene terephthalate (PET), or the like. The thickness of the interlayer may be in the range from about 0.5 mm to about 2.5 mm, in particular from about 0.7 mm to about 1.5 mm. In other embodiments the thickness may be less than 0.5 mm or more than 2.5 mm. Further, in embodiments, the interlayer 330 may comprise multiple polymeric layers or films providing various functionalities to the laminate structure 300. For example, the interlayer 330 may incorporate at least one of a display feature, solar insulation, sound dampening, an antenna, an anti-glare treatment, or an anti-reflective treatment, among others. In particular embodiments, the interlayer 330 is modified to provide ultraviolet (UV) absorption, infrared (IR) absorption, IR reflection, acoustic control/dampening, adhesion promotion, and tint. The interlayer 330 can be modified by a suitable additive such as a dye, a pigment, dopants, etc. to impart the desired property.

In one or more embodiments, the first glass ply 310 or second glass play 320 may be provided with a functional or decorative coating in addition to or in the alternative to the functional or decorative film of the interlayer 330. In embodiments, the coating is at least one of an infrared reflective (IRR) coating, frit, anti-reflective coating, or pigment coating. In an example embodiment of an IRR, the second major surface 204 of the first glass ply 310 or the third major surface 332 of the second glass ply 320 is coated with an infrared-reflective film and, optionally, one or more layers of a transparent dielectric film. In embodiments, the infrared-reflecting film comprises a conductive metal, such as silver, gold, or copper, that reduces the transmission of heat through the coated ply 310, 320. In embodiments, the optional dielectric film can be used to anti-reflect the infrared-reflecting film and to control other properties and characteristics of the coating, such as color and durability. In embodiments, the dielectric film comprises one or more oxides of zinc, tin, indium, bismuth, and titanium, among others. In an example embodiment, the IRR coating includes one or two silver layers each sandwiched between two layers of a transparent dielectric film. In embodiments, the IRR coating is applied using, e.g., physical or chemical vapor deposition or via lamination.

In embodiments, one or both of the first glass ply 310 and the second glass ply 320 includes frit. In embodiments, the frit is applied, e.g., to the first major surface 202 of the first glass ply 310, to the second major surface 204 of the first glass ply 310, and/or to the third major surface 332 of the second glass ply 320. In embodiments, the frit provides an enhanced bonding surface for adhesives such as the interlayer 330 or an adhesive joining the glazing 130 to a bonding surface defining an opening 120 in the vehicle body 110. Additionally, in embodiments, the frit provides a decorative border for the glazing 130. Further, in embodiments, the frit may be used in addition to the IRR coating described above. In embodiments, the frit is an enamel frit. In other embodiments, the frit is designed such that it is ion-exchangeable. That is, the frit can be applied to an ion-exchangeable glass (such as the presently disclosed boroaluminosilicate glass composition) prior to undergoing an ion-exchange treatment. Such frit is configured to allow the exchange of ions between the glass and the treatment bath. In embodiments, the frit is a Bi—Si—B alkali system, a Zn-based Bi-system, a Bi—Zn-system, a Bi-system, an Si—Zn—B—Ti system with no or low Bi, an Si—Bi—Zn—B-alkali system, and/or an Si—Bi—Ti—B—Zn-akali system, among others. An example of an ion-exchangeable frit, including colorant, comprises 45.11 mol % Bi₂O₃, 20.61 mol % SiO₂, 13.56 mol % Cr₂O₃, 5.11 mol % CuO, 3.48 mol % MnO, 3.07 mol % ZnO, 2.35 mol % B₂O₃, 1.68 mol % TiO₂, 1.60 mol % Na₂O, 1.50 mol % Li₂O, 0.91 mol % K₂O, 0.51 mol % Al₂O₃, 0.15 mol % P₂O₅, 0.079 mol % SO₃, 0.076 mol % BaO, 0.062 mol % ZrO₂, 0.060 mol % Fe₂O₃, 0.044 mol % MoO₃, 0.048 mol % CaO, 0018 mol % Nb₂O₅, 0.006 mol % Cl, and 0.012 mol % SrO. Other examples of ion-exchangeable frits are disclosed in U.S. Pat. No. 9,346,708B2 (application Ser. No. 13/464,493, filed May 4, 2012) and U.S. Publication No. 2016/0002104A1 (application Ser. No. 14/768,832, filed Aug. 19, 2015), both of which are incorporated herein by reference in their entireties.

In embodiments, the first glass ply 310 may be provided with a colorant coating comprised of an ink, such as an organicink. In embodiments particularly suitable for such a colorant coating, the colorant coating is applied to the first major surface 202 of the first glass ply 310 or to the second major surface 204 of the first glass ply 310, and the first glass ply 310 is cold-formed against the second glass ply 320. Advantageously, such colorant coatings can be applied to the first glass ply 310 while the first glass ply 310 is in a planar configuration, and then the first glass ply 310 can be cold formed to a curved configuration without disrupting the colorant coating, e.g., organic ink coating. In an embodiment, the colorant coating comprises at least one pigment, at least one mineral filler, and a binder comprising an alkoxysilane functionalized isocyanurate or an alkoxysilane functionalized biuret. Examples of such colorant coatings are described in European Patent No. 2617690B1, incorporated herein by reference in its entirety. Other suitable colorant coatings and methods of applying the colorant coatings are described in U.S. Publication No. 2020/0171800A1 (application Ser. No. 16/613,010, filed on Nov. 12, 2019) and U.S. Pat. No. 9,724,727 (application Ser. No. 14/618,398, filed Feb. 10, 2015), both of which are incorporated herein by reference in their entireties.

In embodiments, the coating is an anti-reflective coating. In particular embodiments, the anti-reflective coating is applied to the first major surface 202 of the first glass ply 310. In embodiments, the anti-reflective coating comprises multiple layers of low and high index materials or low, medium, and high index materials. For example, in embodiments, the anti-reflective coating includes from two to twelve layers of alternating low and high index materials, such as silica (low index) and niobia (high index). In another example embodiment, the anti-reflective coating includes from three to twelve layers of repeating low, medium, and high index materials, such as silica (low index), alumina (medium index), and niboia (high index). In still other embodiments, the low index material in the stack may be an ultra low index material, such as magnesium fluoride or porous silica. In general, anti-reflective coatings having more layers in the stack will perform better at higher angles of incidence than anti-reflective coatings having less layers in the stack. For example, at an angle of incidence of, e.g., greater than 60°, an anti-reflective coating stack having four layers will perform better (less reflection) than an anti-reflective coating stack having two layers. Further, in embodiments, an anti-reflective coating stack having an ultra low index material will perform better (less reflection) than an anti-reflective coating stack having a low index material. Other anti-reflective coatings known in the art may also be suitable for application to the laminate 300.

In embodiments, the glass ply 200 or laminate 300 exhibits at least one curvature comprising a radius of curvature that is in the range of 300 mm to about 10 m along at least a first axis. In embodiments, the glass ply 200 or laminate 300 exhibits at least one curvature comprising a radius of curvature that is in the range of 300 mm to about 10 m along a second axis that is transverse, in particular perpendicular, to the first axis. In other embodiments the glass ply exhibits curvature but the curvature has a radius of curvature less than 300 μm or greater than 10 m. In some embodiments, the curvature is complex and changing.

In embodiments, the curvature(s) are introduced into the glass ply 200 or each glass ply 310, 320 of the glass laminate 300 through a thermal process. The thermal process may include a sagging process that uses gravity to shape the glass ply 200 or glass plies 310, 320 when heated. In the sagging step, a glass ply, such as glass ply 200, is placed on a mold having an open interior, heated in a furnace (e.g., a box furnace, or a lehr furnace), and allowed to gradually sag under the influence of gravity into the open interior of the mold. In one or more embodiments, the thermal process may include a pressing process that uses a mold to shape the glass ply 200 or glass plies 310, 320 when heated or while heating. In some embodiments, two glass plies, such as glass plies 310, 320, are shaped together in a “pair-shaping” process. In such a process, one glass ply is placed on top of another glass ply to form a stack (which may also include an intervening release layer), which is placed on the mold. In embodiments, to facilitate the pair-shaping process, the glass ply 310 used as an inner and/or thinner glass ply has a pair-shaping temperature (temperature at 10¹¹ Poise, i.e., T₁₁ temperature) that is greater than the outer and/or thicker glass ply 320. For example, in embodiments, the inner, thinner glass ply 310 comprised of the presently disclosed boroaluminosilicate glass composition has a T₁₁ temperature in the range of 630° C. to 650° C., and the outer, thicker glass ply 320 has a T₁₁ temperature in the range of about 600° C. to about 610° C. for a soda lime silicate glass or 605° C. to 640° C. (e.g., 605° C. to 625° C.) for a fusion-formable borosilicate glass composition.

In one or more embodiments, the mold may have an open interior for use in a sagging process. The stack and mold are both heated by placing them in the furnace, and the stack is gradually heated to the bend or sag temperature of the glass plies. During this process, the plies are shaped together to a curved shape. Because of the difference in T₁₁ temperature between the inner, thinner glass ply 310 and the outer, thicker glass ply 320, optical distortions that otherwise might be created during pair-forming are substantially diminished or eliminated.

According to an exemplary embodiment, heating time and temperature are selected to obtain the desired degree of curvature and final shape. Subsequently, the glass ply or glass plies are removed from the furnace and cooled. For pair-shaped glass plies, the two glass plies are separated, re-assembled with an interlayer, such as interlayer 330, between the glass plies and heated, e.g., under vacuum to seal the glass plies and interlayer together into a laminate.

In one or more embodiments, only one glass ply is curved using heat (e.g., by a sag process or press process), and the other glass ply is curved using a cold-forming process by pressing the glass ply to be curved into conformity with the already curved glass ply at a temperature less than the softening temperature of the glass composition (in particular at a temperature of 200° C. or less, 100° C. or less, 50° C. or less, or at room temperature). Pressure to cold-form the glass ply against the other glass ply may be provided by, e.g., a vacuum, a mechanical press, or one or more clamps. The cold-formed glass ply may be held into conformity with the curved glass ply via the interlayer and/or mechanically clamped thereto or otherwise coupled.

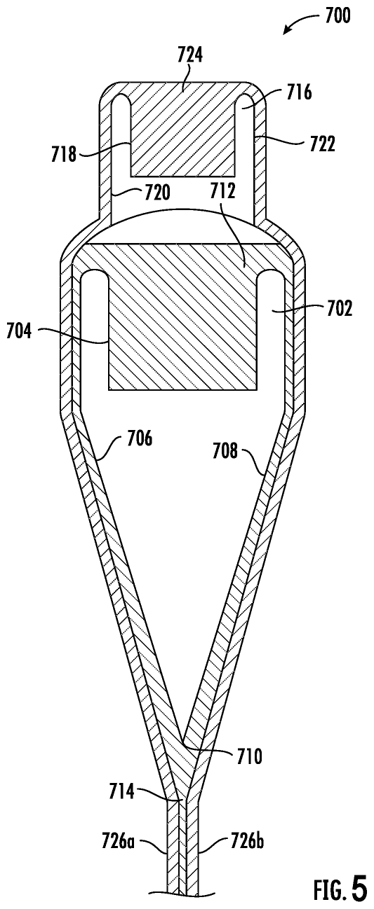

FIG. 4 depicts an exemplary embodiment of a curved glass laminate 400. As can be seen in FIG. 4, the first major surface 202 of the first glass ply 310 has a first curvature depth 410 defined as the maximum depth from planar (dashed line) of the first major surface 202. In embodiments in which the second glass ply 320 is curved, the third major surface 332 of the second glass ply 320 has a second curvature depth 420 defined as the maximum depth from planar (dashed line) of the third major surface 332.

In embodiments, one or both the first curvature depth 410 and the second curvature depth 420 is about 2 mm or greater. Curvature depth may be defined as maximum distance a surface is distanced orthogonally from a plane defined by points on a perimeter of that surface. For example, one or both the first curvature depth 410 and the second curvature depth 420 may be in a range from about 2 mm to about 30 mm. In embodiments, the first curvature depth 410 and the second curvature depth 420 are substantially equal to one another. In one or more embodiments, the first curvature depth 410 is within 10% of the second curvature depth 420, in particular within 5% of the second curvature depth 420. For illustration, the second curvature depth 420 may be about 15 mm, and the first curvature depth 410 would be in a range from about 13.5 mm to about 16.5 mm (or within 10% of the second curvature depth 420).

In one or more embodiments, the first curved glass ply 310 and the second curved glass ply 330 comprise a shape deviation therebetween the first curved glass ply 310 and the second curved glass ply 320 of +5 mm or less as measured by an optical three-dimensional scanner such as the ATOS Triple Scan supplied by GOM GmbH, located in Braunschweig, Germany. In one or more embodiments, the shape deviation is measured between the second major surface 204 and the third major surface 332, or between the first major surface 202 and the fourth major surface 334. In one or more embodiments, the shape deviation between the first glass ply 310 and the second glass ply 320 is about +4 mm or less, about +3 mm or less, about +2 mm or less, about +1 mm or less, about +0.8 mm or less, about +0.6 mm or less, about +0.5 mm or less, about +0.4 mm or less, about +0.3 mm or less, about +0.2 mm or less, or about +0.1 mm or less. As used herein, the shape deviation applies to stacked glass plies (i.e., with no interlayer) and refers to the maximum deviation from the desired curvature between coordinating positions on the respective second major surface 204 and third major surface 332 or the first major surface 202 and the fourth major surface 334.

In one or more embodiments, one of or both the first major surface 202 and the fourth major surface 334 exhibit minimal optical distortion. For example, one of or both the first major surface 202 and the fourth major surface 334 exhibit less than about 400 millidiopters, less than about 300 millidiopters, less than about 250 millidiopters, or less than about 200 millidiopters as measured by an optical distortion detector using transmission optics. A suitable optical distortion detector is supplied by ISRA VISIION AG, located in Darmstadt, Germany, under the tradename SCREENSCAN-Faultfinder. In one or more embodiments, one of or both the first major surface 202 and the fourth major surface 334 exhibit about 190 millidiopters or less, about 180 millidiopters or less, about 170 millidiopters or less, about 160 millidiopters or less, about 150 millidiopters or less, about 140 millidiopters or less, about 130 millidiopters or less, about 120 millidiopters or less, about 110 millidiopters or less, about 100 millidiopters or less, about 90 millidiopters or less, about 80 millidiopters or less, about 70 millidiopters or less, about 60 millidiopters or less, or about 50 millidiopters or less. As used herein, the optical distortion refers to the maximum optical distortion measured on the respective surfaces.

In one or more embodiments, the first major surface 202 or the second major surface 204 of the first curved glass ply 310 exhibits low membrane tensile stress. Membrane tensile stress can occur during cooling of curved plies and laminates. As the glass cools, the major surfaces and edge surfaces (orthogonal to the major surfaces) can develop surface compression, which is counterbalanced by a central region exhibiting a tensile stress. Such stresses can, in certain circumstances, be problematic around the periphery where edge cooling effects set up stresses and bending tools create thermal gradients that generate stresses. The low CTE (e.g., 8 ppm/° C. or less, 7.8 ppm/° C. or less, or 7.5 ppm/° C. or less) associated with embodiments of the presently disclosed boroaluminosilicate glass composition minimizes adverse residual stresses that may arise during the annealing process of hot forming. Such stresses are proportional to the CTE, and thus, by decreasing the CTE of the boroaluminosilicate glass composition, the residual stresses are also decreased.

Bending or shaping can introduce additional surface tension near the edge and causes the central tensile region to approach the glass surface. Accordingly, membrane tensile stress is the tensile stress measured near the edge (e.g., about 10-25 mm from the edge surface). In one or more embodiments, the membrane tensile stress at the first major surface or the second major surface of the first curved glass ply is less than about 7 megaPascals (MPa) as measured by an edge stress meter according to ASTM C1279. An example of such a surface stress meter is an Edge Stress Meter or VRP (both commercially available from Strainoptic Technologies). In one or more embodiments, the membrane tensile stress at the first major surface or the second major surface of the first curved glass ply is about 6 MPa or less, about 5 MPa or less, about 4 MPa or less, or about 3 MPa or less. In one or more embodiments, the lower limit of membrane tensile stress is about 0.01 MPa or about 0.1 MPa. In other embodiments, membrane tensile stress may be neglible (e.g., about 0). As recited herein, stress is designated as either compressive or tensile, with the magnitude of such stress provided as an absolute value.

In one or more embodiments, the laminate 300, 400 may have a thickness of 10 mm or less, 9 mm or less, 8 mm or less, 7 mm or less, or 6 mm or less where the thickness comprises the sum of thicknesses of the first glass ply 310, the second glass ply 320, and the interlayer 330. In various embodiments, the laminate 300, 400 may have a thickness in the range of about 1.8 mm to about 10 mm, or in the range of about 1.8 mm to about 9 mm, or in the range of about 1.8 mm to about 8 mm, or in the range of about 1.8 mm to about 7 mm, or in the range of about 1.8 mm to about 6 mm, or in the range of about 1.8 mm to about 5 mm, or 2.1 mm to about 10 mm, or in the range of about 2.1 mm to about 9 mm, or in the range of about 2.1 mm to about 8 mm, or in the range of about 2.1 mm to about 7 mm, or in the range of about 2.1 mm to about 6 mm, or in the range of about 2.1 mm to about 5 mm, or in the range of about 2.4 mm to about 10 mm, or in the range of about 2.4 mm to about 9 mm, or in the range of about 2.4 mm to about 8 mm, or in the range of about 2.4 mm to about 7 mm, or in the range of about 2.4 mm to about 6 mm, or in the range of about 2.4 mm to about 5 mm, or in the range of about 3.4 mm to about 10 mm, or in the range of about 3.4 mm to about 9 mm, or in the range of about 3.4 mm to about 8 mm, or in the range of about 3.4 mm to about 7 mm, or in the range of about 3.4 mm to about 6 mm, or in the range of about 3.4 mm to about 5 mm. In other embodiments, the laminate thickness may be less than 1.8 mm or greater than 10 mm.

In one or more embodiments the first curved glass ply (or the first glass ply used to form the first curved glass ply) is relatively thin in comparison to the second curved glass ply (or the second glass ply used to form the second curved glass ply). In other words, the second curved glass ply (or the second glass ply used to form the second curved glass ply) has a thickness greater than the first curved glass ply (or the first glass ply used to form the first curved glass ply). In one or more embodiments, the second thickness (or the thickness of the second glass ply used to form the second curved glass ply) is more than two times the first thickness. In one or more embodiments, the second thickness (or the thickness of the second glass ply used to form the second curved glass ply) is in the range from about 1.5 times to about 10 times the first thickness (e.g., from about 1.75 times to about 10 times, from about 2 times to about 10 times, from about 2.25 times to about 10 times, from about 2.5 times to about 10 times, from about 2.75 times to about 10 times, from about 3 times to about 10 times, from about 3.25 times to about 10 times, from about 3.5 times to about 10 times, from about 3.75 times to about 10 times, from about 4 times to about 10 times, from about 1.5 times to about 9 times, from about 1.5 times to about 8 times, from about 1.5 times to about 7.5 times, from about 1.5 times to about 7 times, from about 1.5 times to about 6.5 times, from about 1.5 times to about 6 times, from about 1.5 times to about 5.5 times, from about 1.5 times to about 5 times, from about 1.5 times to about 4.5 times, from about 1.5 times to about 4 times, from about 1.5 times to about 3.5 times, from about 2 times to about 7 times, from about 2.5 times to about 6 times, from about 3 times to about 6 times). In other embodiments, the plies may be otherwise sized, such as the first ply being thicker or the same thickness as the second ply.

In one or more embodiments, the first thickness (or the thickness of the first glass ply used to form the first curved glass ply) is less than 2.0 mm (e.g., 1.95 mm or less, 1.9 mm or less, 1.85 mm or less, 1.8 mm or less, 1.75 mm or less, 1.7 mm or less, 1.65 mm or less, 1.6 mm or less, 1.55 mm or less, 1.5 mm or less, 1.45 mm or less, 1.4 mm or less, 1.35 mm or less, 1.3 mm or less, 1.25 mm or less, 1.2 mm or less, 1.15 mm or less, 1.1 mm or less, 1.05 mm or less, 1 mm or less, 0.95 mm or less, 0.9 mm or less, 0.85 mm or less, 0.8 mm or less, 0.75 mm or less, 0.7 mm or less, 0.65 mm or less, 0.6 mm or less, 0.55 mm or less, 0.5 mm or less, 0.45 mm or less, 0.4 mm or less, 0.35 mm or less, 0.3 mm or less, 0.25 mm or less, 0.2 mm or less, 0.15 mm or less, or about 0.1 mm or less). The lower limit of thickness may be 0.1 mm, 0.2 mm, or 0.3 mm. In some embodiments, the first thickness (or the thickness of the first glass ply used to form the first curved glass ply) is in the range from about 0.1 mm to less than about 2.0 mm, from about 0.1 mm to about 1.9 mm, from about 0.1 mm to about 1.8 mm, from about 0.1 mm to about 1.7 mm, from about 0.1 mm to about 1.6 mm, from about 0.1 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1 mm, from about 0.1 mm to about 0.9 mm, from about 0.1 mm to about 0.8 mm, from about 0.1 mm to about 0.7 mm, from about 0.2 mm to less than about 2.0 mm, from about 0.3 mm to less than about 2.0 mm, from about 0.4 mm to less than about 2.0 mm, from about 0.5 mm to less than about 2.0 mm, from about 0.6 mm to less than about 2.0 mm, from about 0.7 mm to less than about 2.0 mm, from about 0.8 mm to less than about 2.0 mm, from about 0.9 mm to less than about 2.0 mm, or from about 1.0 mm to about 2.0 mm. In other embodiments, the second ply can be thicker than 2.0 mm or thinner than 0.1 mm, such as less than 700 μm, 500 μm, 300 μm, 200 μm, 100 μm, 80 μm, 40 μm, and/or at least 10 μm.

In some embodiments, the second thickness (or the thickness of the second glass ply used to form the second curved glass ply) is about 2.0 mm or greater. For example, the second thickness (or the thickness of the second glass ply used to form the second curved glass ply) is about 2.0 mm or greater, about 2.1 mm or greater, about 2.2 mm or greater, about 2.3 mm or greater, about 2.4 mm or greater, about 2.5 mm or greater, about 2.6 mm or greater, about 2.7 mm or greater, about 2.8 mm or greater, about 2.9 mm or greater, about 3.0 mm or greater, about 3.1 mm or greater, about 3.2 mm or greater, about 3.3 mm or greater, 3.4 mm or greater, 3.5 mm or greater, 3.6 mm or greater, 3.7 mm or greater, 3.8 mm or greater, 3.9 mm or greater, 4 mm or greater, 4.2 mm or greater, 4.4 mm or greater, 4.6 mm or greater, 4.8 mm or greater, 5 mm or greater, 5.2 mm or greater, 5.4 mm or greater, 5.6 mm or greater, 5.8 mm or greater, or 6 mm or greater. In some embodiments the second thickness (or the thickness of the second glass ply used to form the second curved glass ply) is in a range from about 2.0 mm to about 6 mm, from about 2.1 mm to about 6 mm, from about 2.2 mm to about 6 mm, from about 2.3 mm to about 6 mm, from about 2.4 mm to about 6 mm, from about 2.5 mm to about 6 mm, from about 2.6 mm to about 6 mm, from about 2.8 mm to about 6 mm, from about 3 mm to about 6 mm, from about 3.2 mm to about 6 mm, from about 3.4 mm to about 6 mm, from about 3.6 mm to about 6 mm, from about 3.8 mm to about 6 mm, from about 4 mm to about 6 mm, from about 2.0 mm to about 5.8 mm, from about 2.0 mm to about 5.6 mm, from about 2.0 mm to about 5.5 mm, from about 2.0 mm to about 5.4 mm, from about 2.0 mm to about 5.2 mm, from about 2.0 mm to about 5 mm, from about 2.0 mm to about 4.8 mm, from about 2.0 mm to about 4.6 mm, from about 2.0 mm to about 4.4 mm, from about 2.0 mm to about 4.2 mm, from about 2.0 mm to about 4 mm, from about 2.0 mm to about 3.8 mm, from about 2.0 mm to about 3.6 mm, from about 2.0 mm to about 3.4 mm, from about 2.0 mm to about 3.2 mm, or from about 2.0 mm to about 3 mm. In other embodiments the second ply can be thicker than 10.0 mm or thinner than 2.0 mm, such as less than 1.5 mm, 1.0 mm, 700 μm, 500 μm, 300 μm, 200 μm, 100 μm, 80 μm, 40 μm, and/or at least 10 μm.

In one or more specific examples, the second thickness (or the thickness of the second glass ply used to form the second curved glass ply) is from about 2.0 mm to about 3.8 mm, and the first thickness (or the thickness of the first glass ply used to form the first curved glass ply) is in a range from about 0.1 mm to less than about 2.0 mm. In embodiments, the ratio of second thickness to total glass thickness is at least 0.7, or at least 0.75, or at least 0.8, or at least 0.85, or at least 0.9.

In one or more embodiments, the laminate 300, 400 is substantially free of visual distortion as measured by ASTM C1652/C1652M. In specific embodiments, the laminate, the first curved glass ply and/or the second curved glass ply are substantially free of wrinkles or distortions that can be visually detected by the naked eye, according to ASTM C1652/C1652M.

In one or more embodiments, the first major surface 202 or the second major surface 204 comprises a surface compressive stress of less than 3 MPa as measured by a surface stress meter, such as the surface stress meter commercially available under the tradename FSM-6000, from Orihara Industrial Co., Ltd. (Japan) (“FSM”). In some embodiments, the first curved glass ply is unstrengthened (but may optionally be annealed), and exhibits a surface compressive stress of less than about 3 MPa, or about 2.5 MPa or less, 2 MPa or less, 1.5 MPa or less, 1 MPa or less, or about 0.5 MPa or less. In some embodiments, such surface compressive stress ranges are present on both the first major surface and the second major surface.

In one or more embodiments, the first and second glass plies used to form the first curved glass ply and second curved ply are substantially planar prior to being pair shaped to form a first curved glass ply and second curved glass ply. In some instances, one or both of the first glass ply and the second glass ply used to form the first curved glass ply and second curved ply may have a 3D or 2.5D shape that does not exhibit the curvature depth desired and will eventually be formed during the pair shaping process and present in the resulting laminate. Additionally or alternatively, the thickness of the one or both of the first curved glass ply (or the first glass ply used to form the first curved glass ply) and the second curved glass ply (or the second glass ply used to form the second curved glass ply) may be constant along one or more dimension or may vary along one or more of its dimensions for aesthetic and/or functional reasons. For example, the edges of one or both of the first curved glass ply (or the first glass ply used to form the first curved glass ply) and the second curved glass ply (or the second glass ply used to form the second curved glass ply) may be thicker as compared to more central regions of the glass ply.

The length (e.g., longest centerline of surface (e.g., first major surface)), width (e.g., longest dimension of the surface orthogonal to the length), and thickness (e.g., dimension of the ply orthogonal to the length and the width) dimensions of the first curved glass ply (or the first glass ply used to form the first curved glass ply) and the second curved glass ply (or the second glass ply used to form the second curved glass ply) may also vary according to the article application or use. In one or more embodiments, the first curved glass ply (or the first glass ply used to form the first curved glass ply) includes a first length and a first width (the first thickness is orthogonal both the first length and the first width), and the second curved glass ply (or the second glass ply used to form the second curved glass ply) includes a second length and a second width orthogonal the second length (the second thickness is orthogonal both the second length and the second width). In one or more embodiments, either one of or both the first length and the first width is about 0.25 meters (m) or greater. For example, the first length and/or the second length may be in a range from about 1 m to about 3 m, from about 1.2 m to about 3 m, from about 1.4 m to about 3 m, from about 1.5 m to about 3 m, from about 1.6 m to about 3 m, from about 1.8 m to about 3 m, from about 2 m to about 3 m, from about 1 m to about 2.8 m, from about 1 m to about 2.8 m, from about 1 m to about 2.8 m, from about 1 m to about 2.8 m, from about 1 m to about 2.6 m, from about 1 m to about 2.5 m, from about 1 m to about 2.4 m, from about 1 m to about 2.2 m, from about 1 m to about 2 m, from about 1 m to about 1.8 m, from about 1 m to about 1.6 m, from about 1 m to about 1.5 m, from about 1.2 m to about 1.8 m or from about 1.4 m to about 1.6 m. In some embodiments, a surface dimension from perimeter to perimeter through a centroid of the respective surface (e.g., first surface, second surface, monolith major surface, ply surface) is at least 1 mm, at least 1 cm, at least 10 cm, at least 1 m, and/or no more than 10 m, whereby a contained fracture may not result in failure of the respective ply. In other embodiments, the ply may be otherwise sized.

For example, the first width and/or the second width may be in a range from about 0.5 m to about 2 m, from about 0.6 m to about 2 m, from about 0.8 m to about 2 m, from about 1 m to about 2 m, from about 1.2 m to about 2 m, from about 1.4 m to about 2 m, from about 1.5 m to about 2 m, from about 0.5 m to about 1.8 m, from about 0.5 m to about 1.6 m, from about 0.5 m to about 1.5 m, from about 0.5 m to about 1.4 m, from about 0.5 m to about 1.2 m, from about 0.5 m to about 1 m, from about 0.5 m to about 0.8 m, from about 0.75 m to about 1.5 m, from about 0.75 m to about 1.25 m, or from about 0.8 m to about 1.2m. In other embodiments, the ply may be otherwise sized.

In one or more embodiments, the second length is within 5% of the first length (e.g., about 5% or less, about 4% or less, about 3% or less, or about 2% or less). For example if the first length is 1.5 m, the second length may be in a range from about 1.425 m to about 1.575 m and still be within 5% of the first length. In one or more embodiments, the second width is within 5% of the first width (e.g., about 5% or less, about 4% or less, about 3% or less, or about 2% or less). For example if the first width is 1 m, the second width may be in a range from about 1.05 m to about 0.95 m and still be within 5% of the first width.

Having described the glass ply, laminate structure thereof, and uses therefor, the boroaluminosilicate glass composition is now described in more detail. In embodiments, the boroaluminosilicate glass composition comprises from about 55 mol % to about 67 mol % SiO₂, from about 10 mol % to about 13 mol % B₂O₃, from about 11 mol % to about 15 mol % Al₂O₃, and from about 12 mol % to about 16 mol % of alkali oxides, primarily Na₂O. In particular embodiments, the boroaluminosilicate glass composition comprises a ratio of alkali oxides to Al₂O₃ of 0.9 to 1.2, particularly about 1.06. Advantageously, the boroaluminosilicate glass composition provides a fusion flow rate of 1000 lb/h to 4500 lb/h, in particular 2000 lb/h or higher, during fusion forming operations, which enhances the economics of bulk glass production because a relatively high flow rate drives the glass production times down.

In embodiments, the boroaluminosilicate glass composition includes SiO₂ in an amount in the range of about 55 mol % to about 67 mol %. For example, the boroaluminosilicate glass composition includes SiO₂ in an amount in the range from about 55 mol % to about 67 mol %, from about 56 mol % to about 67 mol %, from about 57 mol % to about 67 mol %, from about 58 mol % to about 67 mol %, from about 59 mol % to about 67 mol %, from about 60 mol % to about 67 mol %, from about 61 mol % to about 67 mol %, from about 62 mol % to about 67 mol %, from about 63 mol % to about 67 mol %, from about 64 mol % to about 67 mol %, from about 65 mol % to about 67 mol %, from about 66 mol % to about 67 mol %, from about 55 mol % to about 66 mol %, from about 55 mol % to about 65 mol %, from about 55 mol % to about 64 mol %, from about 55 mol % to about 63 mol %, from about 55 mol % to about 62 mol %, from about 55 mol % to about 61 mol %, from about 55 mol % to about 60 mol %, from about 55 mol % to about 59 mol %, from about 55 mol % to about 58 mol %, from about 55 mol % to about 57 mol %, from about 55 mol % to about 56 mol %, or any range or sub-ranges therebetween. In other embodiments, the glass may have less than 55 mol % SiO₂ or more than 67 mol % SiO₂. Silica contents in this range may beneficially increase the liquidus viscosity of the glass to facilitate fusion forming, while providing the glass favorable chemical and mechanical durability characteristics.

In embodiments, the boroaluminosilicate glass composition comprises B₂O₃ in an amount in the range from about 10 mol % to about 13 mol %, in particular about 11 mol % to about 12 mol %. In various embodiments, the boroaluminosilicate glass composition comprises B₂O₃ in an amount in the range from about 10 mol % to about 13 mol %, from about 10.5 mol % to about 13 mol %, from about 11 mol % to about 13 mol %, from about 11.5 mol % to about 13 mol %, from about 12 mol % to about 13 mol %, from about 12.5 mol % to about 13 mol %, from about 10 mol % to about 12.5 mol %, from about 10 mol % to about 12 mol %, from about 10 mol % to about 11.5 mol %, from about 10 mol % to about 11 mol %, from about 10 mol % to about 10.5 mol %, or any range or sub-ranges therebetween. In other embodiments, the glass may have less than 10 mol % B203 or more than 13 mol % B₂O₃. B₂O₃ in such amounts provides the glass with favorable viscosity characteristics (such as the 10¹¹ poise temperatures described herein), while increasing the connectivity of the glass network, providing favorable mechanical properties.

In embodiments, the boroaluminosilicate glass composition includes Al₂O₃ in an amount in the range from about 11 mol % to about 15 mol %, in particular about 12.5 mol % to about 13.5 mol %. In various embodiments, the boroaluminosilicate glass composition includes Al₂O₃ in an amount in the range from about 11 mol % to about 15 mol %, from about 11 mol % to about 15 mol %, from about 11.5 mol % to about 15 mol %, from about 12 mol % to about 15 mol %, from about 12.5 mol % to about 15 mol %, from about 13 mol % to about 15 mol %, from about 13.5 mol % to about 15 mol %, from about 14 mol % to about 15 mol %, from about 14.5 mol % to about 15 mol %, from about 11 mol % to about 14.5 mol %, from about 11 mol % to about 14 mol %, from about 11 mol % to about 13.5 mol %, from about 11 mol % to about 13 mol %, from about 11 mol % to about 12.5 mol %, from about 11 mol % to about 12 mol %, from about 11 mol % to about 11.5 mol % or any range or sub-ranges therebetween. In other embodiments, the boroaluminosilicate glass may have less than 11 mol % Al₂O₃ or more than 15 mol % Al₂O₃. Al₂O₃ in such amounts may increase the liquidus viscosity of the glass and contribute to the structural network.

In embodiments, the boroaluminosilicate glass composition comprises alkali oxides in an amount in the range from about 12 mol % to about 16 mol %. In embodiments, the alkali oxide used in the boroaluminosilicate glass composition is primarily Na₂O (e.g., Na₂O may be the only alkali oxide or constitute a majority of the alkali oxide content). In certain embodiments, K₂O and/or Li₂O is also used in the boroaluminosilicate glass composition. In various embodiments, the boroaluminosilicate glass composition comprises alkali oxides in an amount in the range from about 12 mol % to about 16 mol %, from about 12.5 mol % to about 16 mol %, from about 13 mol % to about 16 mol %, from about 13.5 mol % to about 16 mol %, from about 14 mol % to about 16 mol %, from about 14.5 mol % to about 16 mol %, from about 15 mol % to about 16 mol %, from about 15.5 mol % to about 16 mol %, from about 12 mol % to about 15.5 mol %, from about 12 mol % to about 15 mol %, from about 12 mol % to about 14.5 mol %, from about 12 mol % to about 14 mol %, from about 12 mol % to about 13.5 mol %, from about 12 mol % to about 13 mol %, from about 12 mol % to about 12.5 mol %, or any ranges and sub-ranges therebetween. In other embodiments, the glass may have less than 12 mol % of alkali oxides or more than 16 mol % of alkali oxides. Na₂O in such amounts may contribute to the viscosity characteristics of the glass.

Of the 12 mol % to 16 mol % of alkali oxides, the boroaluminosilicate glass composition may comprise up to about 1 mol % of Li₂O and/or up to about 2 mol % K₂O. As raw materials, Li₂O and K₂O are significantly more expensive than Na₂O, and one of the advantages of the presently disclosed boroaluminosilicate glass composition is the high fusion flow rate, which reduces production costs. Thus, inclusion of significant amounts of Li₂O and Na₂O could offset the savings provided by the high fusion flow rate. The Li₂O and K₂O additions are not believed to have a detrimental effect on the properties of the disclosed boroaluminosilicate glass composition, and if the cost of these alkali oxides were reduced, then it is believed that the limitations of up to about 1 mol % and up to about 2 mol % of Li₂O and K₂O in embodiments would no longer apply.

In embodiments, the boroaluminosilicate glass composition may also comprises P₂O₅ and/or MgO. In such embodiments, the total amount of such additions is up to about 1 mol %.

In embodiments, the amount of alkali oxide relative to Al₂O₃ exists within a ratio (Na₂O:Al₂O₃). In embodiments, the ratio is from about 0.9 to about 1.2, about 0.95 to about 1.2, about 1 to about 1.2, about 1.05 to about 1.2, about 1.1 to about 1.2, about 1.15 to about 1.2, about 0.9 to about 1.15, about 0.9 to about 1.1, about 0.9 to about 1.05, about 0.9 to about 1, about 0.9 to about 0.95. In a particular embodiment, the ratio is about 1.06.

In embodiments, the glass composition (or the glass article formed therefrom) exhibits a liquidus viscosity of at least 20,000 kP and up to 10,000,000 kP. Advantageously, glass compositions having a liquidus viscosity greater than 1000 kP are less susceptible to baggy warp during fusion draw. As used herein, the term “liquidus viscosity” refers to the viscosity of a molten glass at the liquidus temperature, wherein the term “liquidus temperature” refers to the temperature at which crystals first appear as a molten glass cools down from the melting temperature (or the temperature at which the very last crystals melt away as temperature is increased from room temperature). The liquidus viscosity is determined by the following method. First the liquidus temperature of the glass is measured in accordance with ASTM C829-81 (2015), titled “Standard Practice for Measurement of Liquidus Temperature of Glass by the Gradient Furnace Method.” Next the viscosity of the glass at the liquidus temperature is measured in accordance with ASTM C965-96 (2012), titled “Standard Practice for Measuring Viscosity of Glass Above the Softening Point.” Advantageously, the high liquidus viscosity associated with the presently disclosed boroaluminosilicate glass essentially eliminates the risk of devitrification of the glass during production.

As mentioned, the presently disclosed boroaluminosilicate glass composition is particularly suitable for fusion forming. In many instances, fusion forming takes place on an isopipe comprised of a material containing zircon. In certain instances, the zircon of the isopipe can react with the molten glass to produce undesirable zirconia defects in the final glass product. The reaction between molten glass and a zircon-containing isopipe is a strong function of temperature, and thus, a “zircon breakdown temperature” can be defined as a temperature above which the reaction of zircon with molten glass becomes sufficiently favorable that the resulting zirconia defect level is commercially unacceptable. The zircon breakdown temperature is a function of the composition of the molten glass. Thus, a glass composition having a high reactivity with zircon will have a low zircon breakdown temperature, while a more inert glass composition will have a high zircon breakdown temperature. In one or more embodiments, the presently disclosed boroaluminosilicate glass composition comprises a zircon breakdown temperature of at least 1100° C., at least 1125° C., at 1150° C., at least 1175° C., at least 1200° C., at least 1225° C., at least 1250° C., at least 1275° C. In one or more embodiments, the presently disclosed boroaluminosilicate glass composition comprises a zircon breakdown temperature of up to 1300° C. In one or more embodiments, the presently disclosed boroaluminosilicate glass composition comprises a zircon breakdown temperature in a range from 1100° C. to 1300° C., in particular 1150° C. to 1250° C.

In embodiments, the borosilicate glass composition exhibits a strain point temperature in a range from about 510° C. to about 540° C., about 515° C. to about 540° C., about 520° C. to about 540° C., about 525° C. to about 540° C., about 530° C. to about 540° C., about 535° C. to about 540° C., about 510° C. to about 535° C., about 510° C. to about 530° C., about 510° C. to about 525° C., about 510° C. to about 520° C., about 510° C. to about 515° C., or any ranges or sub-ranges therebetween. In embodiments, the strain point temperature is determined using the beam bending viscosity method of ASTM C598-93 (2013). In embodiments, the strain point is defined as the temperature at which viscosity is 1014.68 poise.

In embodiments, the borosilicate glass composition exhibits an annealing point temperature in a range from about 560° C. to about 590° C., about 565° C. to about 590° C., about 570° C. to about 590° C., about 575° C. to about 590° C., about 580° C. to about 590° C., about 585° C. to about 590° C., about 560° C. to about 585° C., about 560° C. to about 580° C., about 560° C. to about 575° C., about 560° C. to about 570° C., about 560° C. to about 565° C., or any ranges or sub-ranges therebetween. The annealing point is determined using the beam bending viscosity method of ASTM C598-93 (2013). In embodiments, the annealing point is defined as the temperature at which viscosity is 1013.18 poise.

In embodiments, the borosilicate glass composition exhibits a softening point temperature in a range from about 800° C. to about 840° C., about 800° C. to about 835° C., about 800° C. to about 830° C., about 800° C. to about 825° C., about 800° C. to about 820° C., about 800° C. to about 815° C., about 800° C. to about 810° C., about 800° C. to about 805° C., about 805° C. to about 840° C., about 810° C. to about 840° C., about 815° C. to about 840° C., about 820° C. to about 840° C., about 825° C. to about 840° C., about 830° C. to about 840° C., about 835° C. to about 840° C., or any ranges or sub-ranges therebetween. The softening point is determined using the beam bending viscosity method of ASTM C338-93 (2003).

In one or more embodiments, the glass composition or the glass article formed therefrom exhibit a density at 20° C. that is less than 2.4 g/cm³. In embodiments, the density at 20° C. is 2.39 g/cm³ or less, 2.38 g/cm³ or less, 2.37 g/cm³ or less, 2.36 g/cm³ or less, 2.35 g/cm³ or less, 2.34 g/cm³ or less, 2.33 g/cm³ or less, 2.32 g/cm³ or less, or 2.31 g/cm³ or less. In embodiments, the density at 20° C. is at least 2.30 g/cm³. In embodiments, the density is determined using the buoyancy method of ASTM C693-93 (2013). Advantageously, a density below 2.4 g/cm³ is less than the density of soda-lime glass, which is conventionally used in automotive glazing laminates.

As mentioned, the borosilicate glass composition according to the present disclosure is particularly suitable for fusion forming, in particular with a high fusion flow rate. The resulting glass ply can be described as being “fusion-formed.” FIG. 5 depicts an exemplary embodiment of an apparatus 700 for fusion forming a glass ply from a boroaluminosilicate glass composition. The fusion-forming apparatus 700 includes an isopipe 702 defined by a trough 704, a first forming surface 706, and a second forming surface 708. The first forming surface 706 and the second forming surface 708 angle inwardly beneath the trough 704 and meet at a root 710 of the isopipe 702. The presently disclosed borosilicate glass composition 712 is provided to the trough 704 in a molten state, and the borosilicate glass composition 712 overflows the trough 704, forming two streams and running down the forming surfaces 706, 708. The streams of molten glass meet at the root 710 to form the glass ply 714, which cools and is cut from the flowing stream.

In embodiments, the fusion-forming apparatus 700 optionally includes a second isopipe 716 having a second trough 718, a third forming surface 720, and a fourth forming surface 722. A glass composition 724, having the same or different composition as the borosilicate glass composition 712, is provided to the second trough 718 in a molten state and overflows the second trough 718. The molten glass composition 724 flows down the third and fourth forming surfaces 720, 722 where it is directed outwardly around the borosilicate glass composition 712. In this way, the glass composition 724 flows down the first and second forming surfaces 706, 708 outside of the streams of the boroaluminosilicate glass composition 712. At the root 710 of the isopipe 702, the combination of the streams of the boroaluminosilicate glass composition 712 and the streams of the glass composition 724 create a glass ply 714 having cladding layers 726a, 726b. Such cladding layers may mechanically strengthen the glass based on residual stresses developed based on different coefficients of thermal expansions between the compositions 712, 724, or the cladding layers may be chemically strengthenable, such as through ion-exchange treatment. The cladding layers 726a, 726b may also provide other features, such as specific optical properties to the glass ply 714 formed in this manner.

In one or more embodiments, the boroaluminosilicate glass composition disclosed herein has a fusion flow rate of at least 1000 lb/h, at least 1100 lb/h, at least 1200 lb/h, at least 1300 lb/h, at least 1400 lb/h, at least 1500 lb/h, at least 1600 lb/h, at least 1700 lb/h, at least 1800 lb/h, at least 1900 lb/h, at least 2000 lb/h, at least 2100 lb/h, at least 2200 lb/h, at least 2300 lb/h, at least 2400 lb/h, at least 2500 lb/h, at least 2600 lb/h, at least 2700 lb/h, at least 2800 lb/h, at least 2900 lb/h, at least 3000 lb/h, at least 3 100 lb/h, at least 3200 lb/h, at least, 3300 lb/h, at least 3400 lb/h, at least 3500 lb/h, at least 3600 lb/h, at least 3700 lb/h, at least 3800 lb/h, at least 3900 lb/h, or at least 4000 lb/h. In one or embodiments, the fusion flow rate is up to 4500 lb/h. In one or more embodiments, the fusion flow rate in the range from about 1000 lb/h to about 4500 lb/h, about 2000 lb/h to about 3000 lb/h, in particular from about 2200 lb/h to about 2600 lb/h, and most particularly from about 2300 lb/h to about 2500 lb/h.

The fusion forming method offers the advantage that, because the two glass steams flowing over the channel fuse together, neither of the outside surfaces of the resulting glass article comes in contact with any part of the apparatus. Thus, the surface properties of the fusion drawn glass article are not affected by such contact. In particular, the fusion-formed boroaluminosilicate glass does not exhibit draw lines associated with convention float-formed glasses. In embodiments, the fusion-formed borosilicate glass composition of the present disclosure exhibits optical distortions of no greater than 75 millidiopters as measured by an optical distortion detector using transmission optics according to ASTM 1561.

Additionally, one or more embodiments of the the glass ply 200 formed from the boroaluminosilicate glass composition are ion-exchange strengthenable. In the ion exchange process, ions at or near the surface of the glass ply are replaced by—or exchanged with—larger ions having the same valence or oxidation state. In those embodiments in which the glass ply comprises the presently disclosed boroaluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass ply generate a stress.

Ion exchange processes are typically carried out by immersing a glass ply in a molten salt bath (or two or more molten salt baths) containing the larger ions to be exchanged with the smaller ions in the glass ply. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired depth of compression stress (DOC) and compressive stress (CS) of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass ply 200 may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass ply may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass ply. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass ply, the different monovalent ions may exchange to different depths within the glass ply (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass ply is chemically strengthened by an ion exchange treatment, FSM or SCALP may be used depending on which ion is exchanged into the glass sheet. Where the stress in the glass ply is generated by exchanging potassium ions into the glass ply, FSMis used to measure DOC. Where the stress is generated by exchanging sodium ions into the glass sheet, SCALP is used to measure DOC. Where the stress in the glass ply is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass plies is measured by FSM. Central tension or CT is the maximum tensile stress and is measured by SCALP.

In one or more embodiments, the glass sheet may be strengthened to exhibit a DOC that is described as a fraction of the thickness T of the glass ply (as described herein). For example, in one or more embodiments, the DOC may be in the range of about 0.05 T to about 0.25 T. In some instances, the DOC may be in the range of about 20 μm to about 300 μm. In one or more embodiments, the strengthened glass ply may have a CS (which may be found at the surface or a depth within the glass sheet) of about 200 MPa or greater, about 500 MPa or greater, or about 1050 MPa or greater. In one or more embodiments, the strengthened glass ply may have a maximum tensile stress or central tension (CT) in the range of about 20 MPa to about 100 MPa.

### EXAMPLES

Various embodiments of the presently disclosed boroaluminosilicate glass composition are provided in the table below.

TABLE 1
COMPOSITIONS AND PROPERTIES OF EXAMPLES 1-6

| | 1 | 2 | 3 | 4 | 5 | 6 |
|---|---|---|---|---|---|---|
| SiO₂ | 59.8 | 60.1 | 59.7 | 60.0 | 59.5 | 59.8 |
| Al₂O₃ | 14.2 | 14.2 | 14.2 | 14.2 | 14.2 | 14.2 |
| B₂O₃ | 11.3 | 10.8 | 11.4 | 11.9 | 12.3 | 11.9 |
| P₂O₅ | 0.0 | 0.0 | 0.0 | 0.5 | 1.0 | 0.0 |
| Li₂O | 0.0 | 0.0 | 0.0 | 0.0 | 0.0 | 0.0 |
| Na₂O | 14.7 | 14.8 | 13.9 | 12.9 | 12.9 | 14.0 |
| K₂O | 0.0 | 0.0 | 0.0 | 0.0 | 0.0 | 0.0 |
| MgO | 0.0 | 0.0 | 0.80 | 0.47 | 0.0 | 0.0 |
| Density | 2.361 | 2.362 | 2.357 | 2.34 | 2.332 | 2.346 |
| (g/cm³) | | | | | | |
| Strain | 526.4 | 529 | 528.9 | 525.7 | 519.8 | 522.9 |
| Point (° C.) | | | | | | |
| Anneal | 574.6 | 577.6 | 579.8 | 579.2 | 573.2 | 574.7 |
| Point (° C.) | | | | | | |
| Softening | 807.5 | 810.5 | 823.3 | 836.3 | 832.5 | 826 |
| Point (° C.) | | | | | | |
| T₁₁ (° C.) | 643.36 | 649.40 | 654.26 | 657.02 | 651.47 | 651.01 |
| LTCTE | 7.75 | 7.85 | 7.54 | 7.21 | 7.24 | 7.59 |
| (ppm/° C.) | | | | | | |
| Young's | 61.3 | 61.7 | 61.8 | 60.3 | 58.9 | 60.0 |
| Modulus | | | | | | |
| (GPa) | | | | | | |
| Shear | 25.2 | 25.3 | 25.2 | 24.6 | 24.1 | 24.5 |
| Modulus | | | | | | |
| (GPa) | | | | | | |
| Poisson's | 0.219 | 0.219 | 0.226 | 0.226 | 0.223 | 0.225 |
| Ratio | | | | | | |
| Fulchers A | −3.9 | −4.0 | −4.1 | −3.669 | −3.9 | −3.7 |
| Fulchers B | 10358.3 | 10825.7 | 10767.1 | 9493.8 | 9983.1 | 9764.2 |
| Fulchers T₀ | −115.5 | −133.7 | −103.7 | −0.3 | −28.4 | −37 |
| Zircon | 1165 | 1155 | 1190 | 1230 | 1240 | 1180 |
| Breakdown | | | | | | |
| Teperature | | | | | | |
| (° C.) | | | | | | |
| Zircon | 17 | 26 | 16 | 11 | 10 | 20 |
| Breakdown | | | | | | |
| Viscosity | | | | | | |
| (P) | | | | | | |
| 200 P | 1568 | 1589 | 1570 | 1590 | 1592 | 1581 |
| Temp (° C.) | | | | | | |
| 1800 P | 1342 | 1362 | 1354 | 1371 | 1375 | 1360 |
| Temp (° C.) | | | | | | |
| 3 kP | 1396 | 1417 | 1406 | 1423 | 1427 | 1413 |
| Temp (° C.) | | | | | | |
| 4 kP | 1204 | 1222 | 1220 | 1238 | 1242 | 1226 |
| Temp (° C.) | | | | | | |
| 35 kP | 1118 | 1136 | 1137 | 1156 | 1159 | 1143 |
| Temp (° C.) | | | | | | |
| 200 kP | 1016 | 1032 | 1038 | 1058 | 1061 | 1044 |
| Temp (° C.) | | | | | | |
| Liquidus | 707,584 | 35,452 | 96,286 | 7,722,561 | 258,999 | 118,514 |
| Viscosity | | | | | | |
| (kP) | | | | | | |
| Estimated | 2312.0 | 2359.6 | 2438.0 | 2459.8 | 2489.5 | 2411.3 |
| Flow Rate | | | | | | |
| (lb/h) | | | | | | |

Examples 1-6 are exemplary glass compositions according to one or more embodiments of this disclosure. As discussed above, the boroaluminosilicate glasses of the present disclosure are configured for fusion forming. In general, a liquidus viscosity above 500 kP and a temperature at which the viscosity is 200 P (T200P) of less than 1725° C. are needed for fusion forming. As can be seen from Table 1, the liquidus viscosity of these boroaluminosilicate glass compositions is well above the 500 kP necessary for fusion forming the glass composition. Indeed, the lowest liquidus viscosity of the six example compositions is more than 35,000 kP. Further, T200p for these glasses is well below 1725° C., particularly in the range of 1560° C. to 1600° C. Further, the boroaluminosilicate glass compostions shown in Table 1 have fusion flow rates in the range of 2300 lb/h to 2500 lb/h, which are high compared to other glass compositions used for thin, inner plies of automotive glazing laminates. For example, an ion-exchange strengthenable alkali aluminosilicate glass composition (64.85 mol % SiO₂; 9.06 mol % Al₂O₃; 0.93 mol % P₂O₅; 16.9 mol % Na₂O; 2.43 mol % K₂O; 3.65 mol % MgO; 1.95 mol % ZnO; and 0.22 mol % SnO₂) has a fusion flow rate of less than 2000 lb/h, in particular about 1992 lb/h. In this regard, the predicted cost per square foot of the ion-exchange strengthenable alkali aluminosilicate glass composition is about 33% more expensive during fusion forming production.

Also, advantageously, the presently disclosed boroaluminosilicate glass compositions have a density below 2.4 g/cm³. Conventional laminates utilize plies of soda-lime glass, which has a density above 2.4 g/cm³. Thus, the disclosed fusion formable boroaluminosilicate glass composition offers weight savings (and thus enhanced fuel efficiency) based on its density of less than 2.4 g/cm³, in particular 2.37 g/cm³ or less.

The thermal properties of a resulting glass ply are also enhanced by the low temperature coefficient of thermal expansion (LTCTE), which is obtained by measuring expansion of the glass between the temperatures of 0° C. and 300° C. In embodiments, the LTCTE is 9 ppm/° C. or less, 8.5 ppm/° C. or less, 8 ppm/° C. or less, 7.9 ppm/° C. or less, in particular, 7.6 ppm/° C. or less, and particularly 7.4 ppm/° C. or less. In one or more embodiments, the range of LTCTE is from 7 ppm/° C. to 9 ppm/° C. For comparison, the ion-exchange strengthenable alkali aluminosilicate glass composition referenced above has an LTCTE of about 9.95 ppm/° C. The inclusion of B₂O₃ in the presently disclosed glass composition contributes to the lowering of the LTCTE.

As discussed above, the Tu temperature is within a good range to pair-shape with soda lime glass or thick fusion-formable borosilicate glass while avoiding optical distortion. The ion-exchange strengtenable alkali aluminosilicate glass composition referenced above has a lower T₁₁ temperature of about 626° C., which is relatively close to that of soda lime glass or fusion formable borosilicate glass (which are in the range of about 600° C. to about 615° C.).

Further, because of the inclusion of greater than 10 mol % of both Al₂O₃ and B₂O₃, the inventors believe that plies made from the the disclosed glass compostions will exhibit enhanced scratch and indentation resistance.

Table 2, below, provides examples of ion-exchange treatment for Example 3, which demonstrate that the disclosed boroaluminosilicate glass composition is ion-exchange strengthenable. The refractive index of the glass was 1.496 and the stress optical coefficient (SOC) was 36.74, which were used in determining the compressive stress (CS) and depth of compression (DOC) as discussed above

TABLE 2
Example Ion-Exchange Treatments for Boroaluminosilicate Glass

| | CS | DOC |
|---|---|---|
| Treatment | (MPa) | (μm) |
| 430° C. for 4 hrs in 100% | 605.832 | 33.725 |
| KNO₃ | 598.095 | 34.098 |
| | 608.468 | 34.200 |
| | 600.027 | 35.287 |
| 430° C. for 9 hrs in 100% | 541.494 | 49.175 |
| KNO₃ | 538.119 | 49.257 |
| | 539.759 | 49.402 |
| | 538.590 | 49.357 |
| 430° C. for 16 hrs in 100% | 501.567 | 63.515 |
| KNO₃ | 501.422 | 63.659 |
| | 498.155 | 63.528 |
| | 499.314 | 63.714 |

As can be seen in Table 2, the boroaluminosilicate glass composition was ion exchange treated in 100% KNO₃ at 430° C. for 4 hours, 9 hours, and 16 hours. After the four hour treatment, the specimens of Example 3 had a surface compressive stress of about 600 MPa or more and a depth of layer of 30 μm or more. After nine hours of treatment, the specimens of Example 3 had surface compressive stress is less than 550 MPa, and the depth of layer has increased to 45 μm or more. After sixteen hours of treatment, the specimens of Example 3 had surface compressive stress of about 500 MPa, and the depth of layer increased to 60 μm or more.

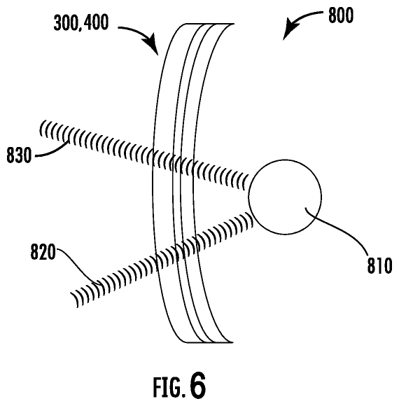

In embodiments, the laminates 300, 400 (or as the glass ply 200) described herein may be used in a system 800 that also includes a sensor 810 as shown in FIG. 6. In embodiments, the laminates 300, 400 are configured to transmit electromagnetic radiation in the visible spectrum and at wavelengths greater than 1500 nm (e.g., short-wave infrared). Signals carried on electromagnetic radiation in these ranges can be transmitted through the laminates 300, 400. FIG. 6 depicts the sensor 810 receiving incoming signals 820 and sending outgoing signals 830 through the laminates 300, 400. For example, in one or more embodiments, the laminate 300, 400 is included as glazing 130 in a vehicle 100 as depicted in FIG. 1. In such an embodiment, the sensor 810 is arranged on the interior of the vehicle 100. In this way, signals 820, 830 are able to be sent from and received by the vehicle 100. In one or more embodiments, the signals 820, 830 have a peak wavelength in the visible light (about 400 nm to about 750 nm) or short-wave infrared spectrums (1500 nm or greater). In embodiments, such signals facilitate autonomous or semi-autonomous driving of the vehicle, open road tolling, telecommunication, traffic monitoring and control, and vehicle-to-vehicle communication, amongst other possibilities. An example of a sensor 810 that can be utilized in the system 800 is LIDAR utilizing one or both of visible light and short-wave infrared radiation. In embodiments of the laminate 300, 400 that include an IRR coating, the IRR coating may be ablated from the ply on which it is applied in the region where the sensor 810 is configured to receive and send signals through the laminate 300, 400. The glass compositions described herein may also find use as protective window covers for liDAR systems disposed outside of a vehicle (as a single ply or laminate).

Embodiments of the present disclosure may be further understood in view of the following aspects:

Aspect (1) pertains to a glass composition, comprising: about 55 mol % to about 67 mol % SiO₂; about 10 mol % to about 13 mol % B₂O₃; about 11 mol % to about 15 mol % Al₂O₃; and about 12 mol % to about 16 mol % alkali oxide, wherein the glass composition comprises a temperature at which a viscosity of the borosilicate glass composition is 10¹¹ P from about 630° C. to about 650° C.

Aspect (2) pertains to the glass composition according to the aspect (1), comprising from about 11 mol % to about 12 mol % B₂O₃.

Aspect (3) pertains to the glass composition according to the aspect (1) or the aspect (2), comprising from about 12.5 mol % to about 13.5 mol % Al₂O₃.

Aspect (4), pertains to the glass composition according to any of the aspects (1)-(3), wherein the alkali oxide comprises at least one of Li₂O, Na₂O, or K₂O.

Aspect (5) pertains to the glass composition according to the aspect (4), comprising at most 1 mol % Li₂O.

Aspect (6) pertains to the glass composition according to the aspects (4)-(5), comprising at most 2 mol % K₂O.

Aspect (7) pertains to the glass composition according to the aspects (1)-(3), wherein the alkali oxide consists of Na₂O.

Aspect (8) pertains to the glass composition according to the aspects (1)-(7), wherein a ratio of alkali oxide to Al₂O₃ is in a range from about 0.9 to about 1.2.

Aspect (9) pertains to the glass composition according to any of the aspects (1)-(8), comprising one or both of P₂O₅ and MgO, wherein the amount of P₂O₅ and MgO is at most 1 mol %.

Aspect (10) pertains to the glass composition according to any of the aspects (1)-(9), comprising a liquidus viscosity in a range from 20,000 kP to 10,000,000 kP.

Aspect (11) pertains to the glass composition according to any of the aspects (1)-(10), comprising a fusion flow rate of 1000 lb/h to 4500 lb/h.

Aspect (12) pertains to the glass composition according to any of the aspects (1)-(11), comprising a density of at least 2.3 g/cm³ and less than 2.4 g/cm³.

Aspect (13) pertains to the glass composition according to any of the aspects (1)-(13), comprising a coefficient of thermal expansion in a range from 7 ppm/° C. to 9 ppm/° C.

Aspect (14) pertains to the glass composition according to any of the aspects (1)-(13), comprising a zircon breakdown temperature in a range from 1100° C. to 1300° C.

Aspect (15) pertains to a laminate, comprising: a first glass ply comprising the glass composition according to any of claims 1-14; a second glass ply comprising a second glass composition; and an interlayer bonding the first glass ply to the second glass ply.

Aspect (16) pertains to the laminate of the aspect (15), wherein the second glass ply is thicker than the first glass ply.

Aspect (17) pertains to the laminate of the any of the aspects (15)-(16), wherein the first glass ply comprises a first major surface and a second major surface opposite to the first major surface and a thickness between the first major surface and the second major surface, wherein the thickness is from 0.1 mm to 2 mm.

Aspect (18) pertains to the laminate according to the aspect (17), wherein the thickness is from about 0.3 mm to about 1.1 mm.

Aspect (19) pertains to a vehicle, comprising: a body defining an interior of the vehicle and at least one opening; an automotive glazing comprising the laminate of any one of claims 15-18 disposed in the at least one opening; wherein the first glass ply is arranged facing the interior of the vehicle and the first glass ply faces an exterior of the vehicle.

Aspect (20) pertains to the vehicle of the aspect (19), wherein the automotive glazing is at least one of a sidelight, a windshield, a rear window, a window, or a sunroof.

Aspect (21) pertains to a method of forming a glass ply, comprising: overflowing a trough in an isopipe with at least two streams of a glass composition comprising from about 55 mol % to about 67 mol % of SiO₂, about 10 mol % to about 13 mol % B₂O₃, from about 11 mol % to about 15 mol % Al₂O₃, and from about 12 mol % to about 16 mol % alkali oxide; fusing the at least two streams of the glass composition at a root of the isopipe to form the glass ply.

Aspect (22) pertains to the method of the aspect (21), wherein the glass composition flows at a rate of 1000 lb/h to 4500 lb/h during the steps of overflowing and fusing.

Aspect (23) pertains to the method of the aspect (21) or the aspect (22), wherein the glass composition comprises a liquidus viscosity of 20,000 kP to 10,000,000 kP.

Aspect (24) pertains to the method according to any of the aspects (21)-(23), wherein the glass composition comprises from about 11 mol % to about 12 mol % B₂O₃.

Aspect (25) pertains to the method according to any of the aspects (21)-(24), wherein the glass composition comprises from about 12.5 mol % to about 13.5 mol % Al₂O₃.

Aspect (26) pertains to the method of any of the aspects (21)-(25), wherein the alkali oxide comprises at least one of Li₂O, Na₂O, or K₂O.

Aspect (27) pertains to the method of the aspect (26), wherein the alkali oxide comprises at most 1 mol % Li₂O.

Aspect (28) pertains to the method of the aspect (26) or the aspect (27), wherein the alkali oxide comprises at most 2 mol % K₂O.

Aspect (29) pertains to the method of any of the aspects (21)-(25), wherein the alkali oxide consists of Na₂O.

Aspect (30) pertains to the method of any of the aspects (21)-(29), wherein a ratio of alkali oxide to Al₂O₃ is in a range from about 0.9 to about 1.2.

Aspect (31) pertains to the method according to any of the aspects (21)-(30), wherein the glass composition comprises one or both of P₂O₅ and MgO, wherein the amount of P₂O₅ and MgO is at most 1 mol %.

Aspect (32) pertains to the method according to any of the aspects (21)-(31), wherein the glass composition comprises a zircon breakdown temperature of at least 1100° C.

Aspect (33) pertains to a method, comprising: arranging a stack comprising a first glass play and a second glass ply on a bending ring comprising an open interior, wherein the first glass ply comprises a first temperature at which a viscosity of the first glass ply is 10¹¹ Poise, the second glass ply comprises a second temperature at which a viscosity of the second glass ply is 10¹¹ Poise, and the first temperature is different from the second temperature; heating the stack to a temperature at which the stack sags into the open interior of the bending ring; wherein the first glass ply comprises a first glass composition comprising from about 55 mol % to about 67 mol % of SiO₂, about 10 mol % to about 13 mol % B₂O₃, from about 11 mol % to about 15 mol % Al₂O₃, and from about 12 mol % to about 16 mol % alkali oxide.

Aspect (34) pertains to the method of the aspect (33), wherein the second glass ply is thicker than the first glass ply and wherein the first temperature is greater than the second temperature.

Aspect (35) pertains to the method of the aspect (33) or the aspect (34), wherein the first glass composition comprises a temperature at which a viscosity of the first glass composition is 10¹¹ P from about 630° C. to about 650° C.

Aspect (36) pertains to the method of any of the aspects (33)-(35), wherein the second glass composition comprises a temperature at which a viscosity of the second glass composition is 10¹¹ P from about 600° C. to about 615° C.

Aspect (37) pertains to the method of any of the aspects (33)-(36), wherein the first glass ply comprises a thickness of less than 2 mm and the second glass ply comprises a thickness of 2 mm or more.

Aspect (38) pertains to the method of any of the aspects (33)-(37), wherein the first glass composition comprises from about 11 mol % to about 12 mol % B₂O₃.

Aspect (39) pertains to the method of any of the aspects (33)-(38), wherein the first glass composition comprises from about 12.5 mol % to about 13.5 mol % Al₂O₃.

Aspect (40) pertains to the method of any of the aspects (33)-(39), wherein the alkali oxide comprises at least one of Li₂O, Na₂O, or K₂O.

Aspect (41) pertains to the method of the aspect (40), wherein the alkali oxide comprises at most 1 mol % Li₂O.

Aspect (42) pertains to the method of the aspect (40) or the aspect (41), wherein the alkali oxide comprises at most 2 mol % K₂O.

Aspect (43) pertains to the method of any of the aspects (33)-(39), wherein the alkali oxide consists of Na₂O.

Aspect (44) pertains to the method of any of the aspects (33)-(43), wherein a ratio of alkali oxide to Al₂O₃ is in a range from about 0.9 to about 1.2.

Aspect (45) pertains to the method of any of the aspects (33)-(43), wherein the second glass composition comprises a soda lime silicate glass composition.

Aspect (46) pertains to the method of any of the aspects (33)-(45), wherein the second glass composition comprises a borosilicate glass composition and wherein the second glass ply is fusion-formed with a thickness of 3 mm or greater.

Aspect (47) pertains to the method of aspect (46), wherein the borosilicate glass composition comprises 74 mol % to 80 mol % of SiO₂, 2.5 mol % to 5 mol % of Al₂O₃, 11.5 mol % to 14.5 mol % B203, 4.5 mol % to 8 mol % Na₂O, 0.5 mol % to 3 mol % K₂O, 0.5 mol % to 2.5 mol % MgO, and 0 mol % to 4 mol % CaO.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A glass composition, comprising:
about 55 mol % to about 67 mol % SiO₂;
about 10 mol % to about 13 mol % B₂O₃;
about 11 mol % to about 15 mol % Al₂O₃; and
about 12 mol % to about 16 mol % alkali oxide;
wherein the glass composition comprises a temperature at which a viscosity of the borosilicate glass composition is 10¹¹ P from about 630° C. to about 650° C.

2. The glass composition of claim 1, comprising from about 11 mol % to about 12 mol % B₂O₃.

3. The glass composition of claim 1, comprising from about 12.5 mol % to about 13.5 mol % Al₂O₃.

4. (canceled)

5. The glass composition of claim 1, comprising at most 1 mol % Li₂O and at most 2 mol % K₂O.

6. (canceled)

7. The glass composition of claim 1, wherein the alkali oxide consists of Na₂O.

8. The glass composition of claim 1, wherein a ratio of alkali oxide to Al₂O₃ is in a range from about 0.9 to about 1.2.

9. The glass composition of claim 1, comprising one or both of P₂O₅ and MgO, wherein the amount of P₂O₅ and MgO is at most 1 mol %.

10. The glass composition of claim 1, comprising a liquidus viscosity in a range from 20,000 kP to 10,000,000 kP and a fusion flow rate of 1000 lb/h to 4500 lb/h.

11. (canceled)

12. The glass composition according to claim 1, comprising a density of at least 2.3 g/cm³ and less than 2.4 g/cm³.

13. The glass composition according to claim 1, comprising a coefficient of thermal expansion in a range from 7 ppm/° C. to 9 ppm/° C. and a zircon breakdown temperature in a range from 1100° C. to 1300° C.

14. (canceled)

15. A laminate, comprising:
a first glass ply comprising the glass composition according to claim 1;
a second glass ply comprising a second glass composition; and
an interlayer bonding the first glass ply to the second glass ply, wherein the second glass ply is thicker than the first glass ply, wherein the first glass ply comprises a first major surface and a second major surface opposite to the first major surface and a thickness between the first major surface and the second major surface, wherein the thickness is from 0.1 mm to 1.1 mm.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A method, comprising:
arranging a stack comprising a first glass play and a second glass ply on a bending ring comprising an open interior, wherein the first glass ply comprises a first temperature at which a viscosity of the first glass ply is 10¹¹ Poise, the second glass ply comprises a second temperature at which a viscosity of the second glass ply is 10¹¹ Poise, and the first temperature is different from the second temperature;
heating the stack to a temperature at which the stack sags into the open interior of the bending ring;
wherein the first glass ply comprises a first glass composition comprising from about 55 mol % to about 67 mol % of SiO₂, about 10 mol % to about 13 mol % B₂O₃, from about 11 mol % to about 15 mol % Al₂O₃, and from about 12 mol % to about 16 mol % alkali oxide.

34. The method of claim 33, wherein the second glass ply is thicker than the first glass ply and wherein the first temperature is greater than the second temperature.

35. The method of claim 33, wherein the first glass composition comprises a temperature at which a viscosity of the first glass composition is 10¹¹ P from about 630° C. to about 650° C.

36. The method of claim 35, wherein the second glass composition comprises a temperature at which a viscosity of the second glass composition is 10¹¹ P from about 600° C. to about 615° C.

37. (canceled)

38. The method of claim 33, wherein the first glass composition comprises from about 11 mol % to about 12 mol % B₂O₃ and from about 12.5 mol % to about 13.5 mol % Al₂O₃.

39. (canceled)

40. (canceled)

41. (canceled)

42. (canceled)

43. The method of claim 33, wherein the alkali oxide consists of Na₂O.

44. The method of claim 33, wherein a ratio of alkali oxide to Al₂O₃ is in a range from about 0.9 to about 1.2.

45. (canceled)

46. The method of claim 33, wherein the second glass composition comprises a borosilicate glass composition and wherein the second glass ply is fusion-formed with a thickness of 3 mm or greater.

47. The method of claim 46, wherein the borosilicate glass composition comprises 74 mol % to 80 mol % of SiO₂, 2.5 mol % to 5 mol % of Al₂O₃, 11.5 mol % to 14.5 mol % B203, 4.5 mol % to 8 mol % Na₂O, 0.5 mol % to 3 mol % K₂O, 0.5 mol % to 2.5 mol % MgO, and 0 mol % to 4 mol % CaO.
